(19) United States
(12) Patent Application Publication
(10) Pub. No.: US 2011/0141008 A1
(43) Pub. Date: Jun. 16, 2011

(54) MULTIMEDIA PLAYING DEVICE AND OPERATION METHOD THEREOF

(76) Inventors: Chia-Hsun Wu, Taipei City (TW); Chih-Wen Hsieh, Taipei City (TW); Alejandro Zamudio Sanchez, Taipei City (TW)

(21) Appl. No.: 12/965,216

(22) Filed: Dec. 10, 2010

(30) Foreign Application Priority Data
Dec. 10, 2009 (TW) 098142265

(51) Int. Cl. G06F 3/01

(52) U.S. Cl. 345/156

(57) ABSTRACT

A multimedia playing device and an operation method thereof are provided. The multimedia playing device stores an image having a plurality of multimedia options. The operation method sequentially includes the following steps. A portion of the image is defined as a projecting area. The portion of the image corresponding to the projecting area is projected. A movement of the multimedia playing device is sensed. According to the movement of the multimedia playing device, the projecting area is moved in the image. Thereby, the multimedia options are presented in a projecting mode, and a user can browse the multimedia options in a dynamic sensing mode thus to facilitate search and selection.

### CROSS REFERENCE TO RELATED APPLICATIONS

This Non-provisional application claims priority under 35 U.S.C. §119(a) on Patent Application No(s). 098142265 filed in Taiwan, Republic of China on Dec. 10, 2009, the entire contents of which are hereby incorporated by reference.

### BACKGROUND OF THE INVENTION

1. Field of Invention

This invention relates to a playing device and an operation method thereof and, more particularly, to a multimedia playing device and an operation method thereof.

2. Description of the Related Art

Projectors capable of easily projecting large-scale images have been generally used in companies and families thus to facilitate view and enjoyment by a plurality of people at the same time. However, the current projector only has a projecting function. In other words, when a user is to change projected contents, the user mostly needs to rely on a remote controller or an electronic apparatus connected with the projector.

To improve portability of the projectors, manufacturers in the art further release micro-projectors to allow the micro-projectors to be capable of being combined with various kinds of electronic products, such as a cellular phone, a personal digital assistant and so on, thus to facilitate use and carry by consumers.

### SUMMARY OF THE INVENTION

This invention is to provide a multimedia playing device and an operation method thereof. Besides projecting multimedia options in a projecting mode, a user browses and controls contents projected by a projecting module in a dynamic sensing mode thus to improve convenience in use.

The embodiment of the invention provides an operation method of a multimedia playing device. The multimedia playing device stores an image having a plurality of multimedia options. The operation method includes the following steps. A portion of the image is defined as a projecting area. The portion of the image corresponding to the projecting area is projected. A movement of the multimedia playing device is sensed. According to the movement of the multimedia playing device, the projecting area is moved in the image.

In one embodiment of the invention, the operation method may further include the following steps. An operation portion is defined in the projecting area. When one of the multimedia options corresponds to the operation portion, a playing instruction is displayed at the operation portion.

The embodiment of the invention further provides a multimedia playing device including a storage module, a projecting module, a sensing module, and a control module. The storage module stores an image having a plurality of multimedia options, and one portion of the image is defined as a projecting area. The projecting module projects the portion of the image corresponding to the projecting area. The sensing module generates a sensing signal according to a movement of the multimedia playing device. The control module is coupled with the storage module, the projecting module, and the sensing module. According to the sensing signal, the control module moves the projecting area in the image.

In one embodiment of the invention, an operation portion may be defined in the projecting area. If one of the multimedia options corresponds to the operation portion, the control module may display a playing instruction at the operation portion.

To sum up, according to the multimedia playing device and the operation method thereof in the invention, the projecting module of the multimedia playing device projects the image stored in the storage module to generate the projecting area. The image has a plurality of multimedia options. The sensing module dynamically senses a movement direction and distance of the multimedia playing device to generate the sensing signal, and the control module changes the portion of the image in the projecting area according to the sensing signal. In other words, the user directly moves the multimedia playing device to browse and control the contents of the image projected by the projecting module.

Thereby, the image is presented in the projecting mode, such that a displaying mode of the image is more lively and interesting. The sensing module senses the movement of the multimedia playing device, such that the user operates the multimedia playing device more intuitively thus to improve the convenience in use.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a multimedia playing device according to one preferred embodiment of the invention;

FIG. 2 is a schematic diagram showing a multimedia playing device in use according to one preferred embodiment of the invention;

FIG. 3 is a schematic diagram showing a multimedia playing device in another form according to one preferred embodiment of the invention;

FIG. 4 is a schematic diagram showing a multimedia playing device in use according to one embodiment of the invention;

FIG. 5 is a schematic diagram showing a multimedia playing device in a third form according to one preferred embodiment of the invention; and

FIG. 6 is a flow chart showing an operation method of a multimedia playing device according to one preferred embodiment of the invention.

### DETAILED DESCRIPTION OF THE INVENTION

A multimedia playing device and an operation method thereof in preferred embodiments of this invention are described hereinbelow according to related drawings, and the same elements are marked by the same reference numbers.

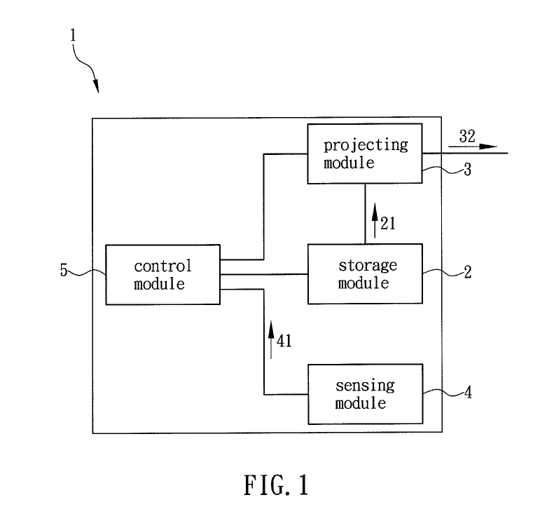

FIG. 1 is a schematic diagram showing a multimedia playing device according to one preferred embodiment of the invention. In FIG. 1, a multimedia playing device 1 includes a storage module 2, a projecting module 3, a sensing module 4, and a control module 5. The control module 5 is coupled with the storage module 2, the projecting module 3, and the sensing module 4. In the embodiment, coupling refers to direct or indirect connection including electrical connection and/or signal reception and transmission. The multimedia playing device 1 in the embodiment may be a personal digital assistant (PDA), an e-book, an electronic dictionary, a mobile communication device, a hand-held personal computer (PC), an ultra mobile personal computer (UMPC), a global positioning system (GPS), a portable game device, a digital still camera (DSC), a digital video (DV) and so on.

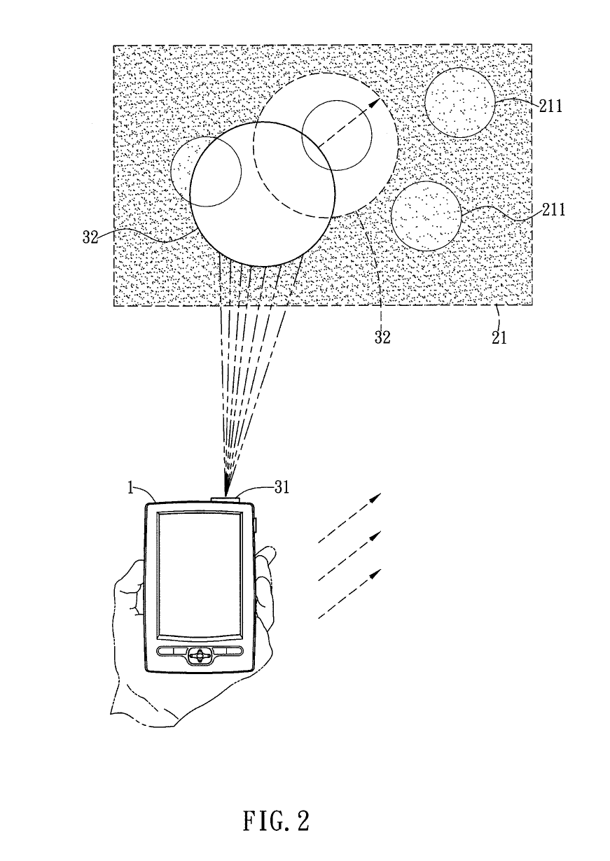

Please refer to FIG. 1 and FIG. 2 together. FIG. 2 is a schematic diagram showing the multimedia playing device 1 in use according to one preferred embodiment of the invention. The storage module 2 stores an image 21 having a plurality of multimedia options 211, and a portion of the image 21 is defined as a projecting area 32. The multimedia options 211 may include multimedia data such as music data or video data. The video data may be a still video, such as but not limited to an image or a photo, or a dynamic video, and the multimedia options 211 may also include a data file or data set by a user. Further, each of the multimedia options 211 corresponding to the music data or the video data has a corresponding icon such as a music CD cover, a film poster, an image, a photo and so on.

A size and shape of the image 21 are not limited in the embodiment and can be set or modified by the designers or users. Further, the size of the image 21 may be determined according to the number of the multimedia options 211. In addition, a range of the image 21 displayed in FIG. 2 represents the size of the image 21 and is not projected actually, and the range which the user can see is the range of the projecting area 32.

The projecting module 3 may have a micro-projector 31, and the user may use the projecting module 3 to project the portion of the image 21 corresponding to the projecting area 32 onto surroundings, such as a wall, a platy object, or other surroundings. In detail, the projecting module 3 projects the portion of the image 21 to generate the projecting area 32 and operation by the user. In the embodiment, the projecting area 32 is circular. However, the invention is not limited thereto. The projecting area 32 may also be rectangular, square, or in other shapes.

According to a movement of the multimedia playing device 1, the sensing module 4 generates a sensing signal 41. The sensing module 4 may have a movement sensing element, and the movement sensing element senses a movement direction and/or distance of the multimedia playing device 1 to generate the sensing signal 41. That is, according to the movement direction of the multimedia playing device 1, the movement distance of the multimedia playing device 1, or the movement direction and distance of the multimedia playing device 1, the movement sensing element generates the sensing signal 41.

According to and corresponding to the sensing signal 41, the control module 5 moves the projecting area 32 in the image 21. That is, with the movement of the multimedia playing device 1, the projecting module 3 may correspondingly project different portions of the image 21.

In detail, the user holds the multimedia playing device 1 and project the portion of the image 21 onto the surroundings via the projecting module 3, and the portion of the image 21 may be presented in the projecting area 32. Certainly, a portion of the multimedia option 211 may be presented in the projecting area 32, or a plurality of the multimedia options 211 may be presented. If the user does not see the multimedia option 211 to be selected in the projecting area 32, the user may directly move the multimedia playing device 1 to search for the multimedia option 211. The sensing module 4 generates the sensing signal 41 according to the movement direction and/or distance of the multimedia playing device 1, and the control module 5 controls the projecting module 3 to change the portion of the image 21 projected in the projecting area 32 according to the sensing signal 41.

In FIG. 2, when the user moves the multimedia playing device 1 toward the upper right, the image 21 does not move. According to the movement direction and/or distance of the multimedia playing device 1, the projecting area 32 displays corresponding contents of the image 21. The image 21 relatively moves toward the bottom left. Thereby, the user may search for the multimedia option 211 at the upper right of the image 21. When the multimedia option 211 is wholly located in the projecting area 32, most of the multimedia option 211 is located in the projecting area 32, or the multimedia option 211 is located in the center of the projecting area 32, the user can select and operate the multimedia option 211.

Therefore, in the embodiment, the multimedia playing device 1 presents the image 21 and the multimedia options 211 in a projecting mode, and the user can operate the multimedia playing device 1 in a direct moving mode, such that the user operates the multimedia playing device 1 more intuitively thus to improve convenience in use.

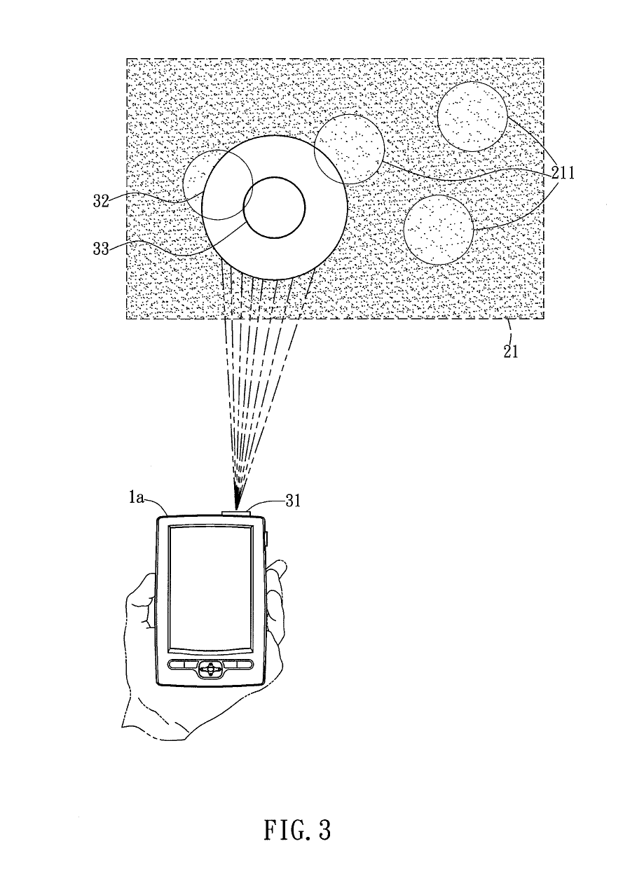

FIG. 3 is a schematic diagram showing a multimedia playing device according to one preferred embodiment of the invention. In FIG. 3, a projecting area 32 in the embodiment has an operation portion 33 therein, and the operation portion 33 may be located in the center of the projecting area 32. However, the invention is not limited thereto. A displaying state and shape of an icon of the operation portion 33 are not limited and may be built in a multimedia playing device 1a or set by the user, and the icon of the operation portion 33 may also not be displayed. That is, although the projecting area 32 does not display the icon of the operation portion 33, the projecting area 32 still has the operation portion 33.

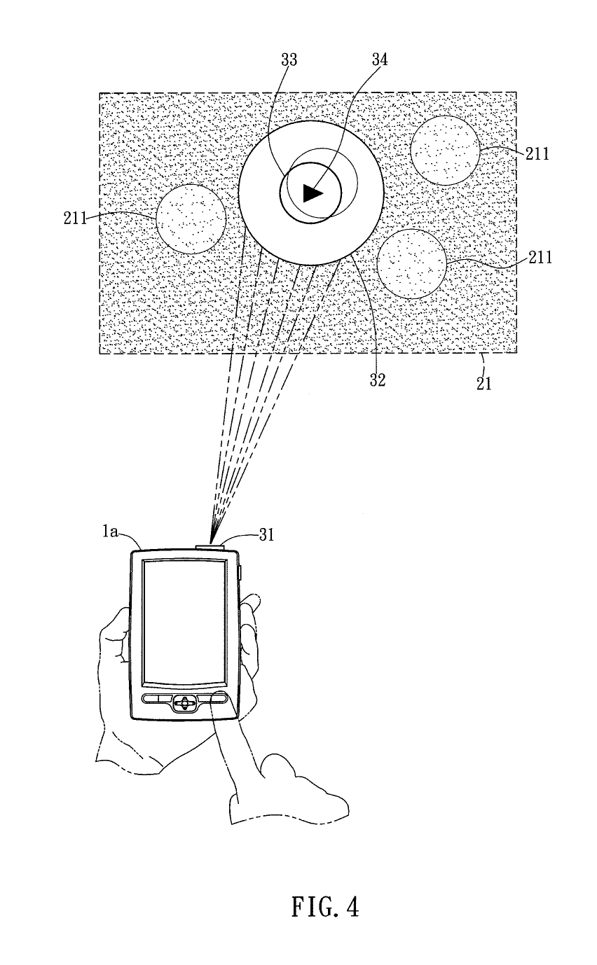

FIG. 4 is a schematic diagram showing the multimedia playing device in use in the embodiment. In FIG. 4, the user holds the multimedia playing device 1a to move toward the upper right, and the projecting area 32 also moves toward the upper right. If one of multimedia options 211 is just located at the location of the operation portion 33 or most of the multimedia option 211 is located at the location of the operation portion 33, the projecting area 32 displays a playing instruction 34 at the operation portion 33 and/or the multimedia option 211. If the multimedia option 211 is just the multimedia option 211 which the user is to select, the user can touch a button of the multimedia playing device 1a to select the multimedia option 211.

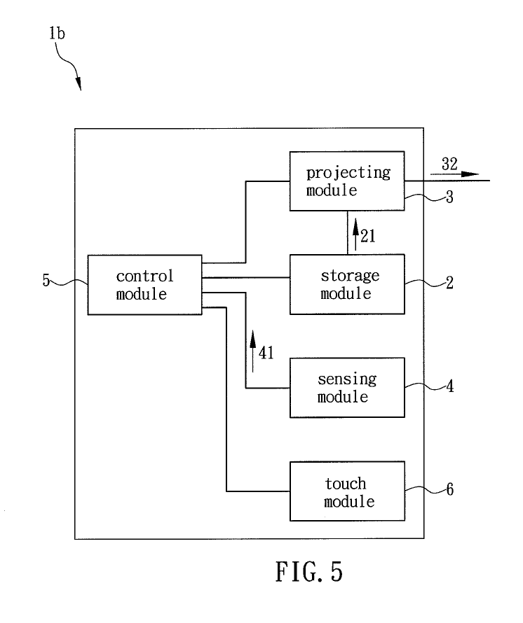

FIG. 5 is a schematic diagram showing a multimedia playing device in a third form according to one preferred embodiment of the invention. In FIG. 5, a multimedia playing device 1b in the embodiment further includes a touch module 6 coupled with a control module 5. The touch module 6 has a touch panel, and the touch module 6 receives a touch signal generated by operation of the user. In other words, the user writes characters, scrawl photos, or scrawl drawings on the touch panel, and the touch module 6 displays the characters written by the user, the scrawled photos, or the scrawled drawings at the touch panel. Further, the control module 5 projects the image displayed by the touch panel onto the surroundings via a projecting module 3.

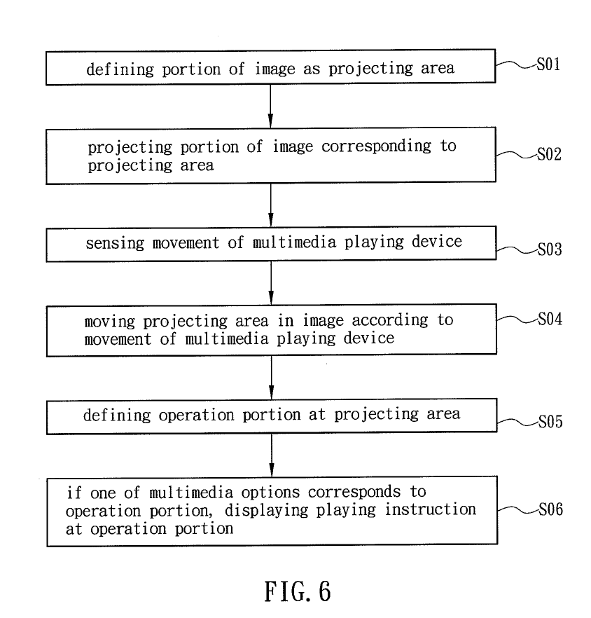

FIG. 6 is a flow chart showing an operation method of a multimedia playing device according to one preferred embodiment of the invention. In FIG. 6, the operation method of the multimedia playing device in the embodiment may be applied to the multimedia playing device 1 in FIG. 1. The operation method of the multimedia playing device sequentially includes step S01 to step S04.

Please refer to FIG. 1 to FIG. 4. In step S01, a portion of an image 21 is defined as a projecting area 32. In step S02, the portion of the image 21 corresponding to the projecting area 32 is projected. If a multimedia option 211 to be selected is not seen in the projecting area 32, the multimedia playing device 1 is directly moved along with change of projected and displayed contents of the portion of the image 21. In step S03, a movement of the multimedia playing device 1 is sensed. A sensing module 4 senses a movement direction and/or distance of the multimedia playing device 1 to generate a sensing signal 41. In step S04, according to the movement of the multimedia playing device 1, the projecting area 32 is moved in the image 21, and the control module 5 controls the projecting module 3 to project the portion of the image 21 in the projecting area 32 according to and corresponding to the sensing signal 41.

In addition, the operation method of the multimedia playing device also be applied to the multimedia playing device 1a in FIG. 3, and the operation method further includes step S05 and S06. However, the invention is not limited thereto. In step S05, an operation portion 33 is defined in the projecting area 32, and the operation portion 33 operates the multimedia option 211 located in the projecting area 32. In step S06, when one of the multimedia options 211 corresponds to the operation portion 33, a playing instruction 34 is displayed at the operation portion 33. At that moment, the button at the multimedia playing device 1a is touched to select the multimedia option 211.

The operation method of the multimedia playing device in the embodiment is already described in detail by applying to the multimedia playing devices 1, 1a as shown from FIG. 1 to FIG. 4. Therefore, it is not described herein for a concise purpose.

To sum up, according to the multimedia playing device and the operation method thereof in the embodiments of the invention, the projecting module of the multimedia playing device projects the image stored in the storage module to generate the projecting area. The image has a plurality of multimedia options. The sensing module dynamically senses the movement direction and distance of the multimedia playing device to generate the sensing signal, and the control module changes the portion of the image in the projecting area according to the sensing signal. In other words, the user directly moves the multimedia playing device to browse and control the contents of the image projected by the projecting module.

Thereby, the image is presented in the projecting mode, such that a displaying mode of the image is more lively and interesting. The sensing module senses the movement of the multimedia playing device, such that the user operates the multimedia playing device more intuitively thus to improve the convenience in use.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An operation method of a multimedia playing device, the multimedia playing device storing an image having a plurality of multimedia options, the operation method comprising the following steps of:
defining a portion of the image as a projecting area;
projecting the portion of the image corresponding to the projecting area;
sensing a movement of the multimedia playing device; and
moving the projecting area in the image according to the movement of the multimedia playing device.

2. The operation method according to claim 1, further comprising the following steps of:
defining an operation portion in the projecting area; and
when one of the multimedia options corresponding to the operation portion, displaying a playing instruction at the operation portion.

3. The operation method according to claim 1, wherein the multimedia playing device has a movement sensing element for sensing the movement of the multimedia playing device.

4. The operation method according to claim 1, wherein the multimedia playing device is a personal digital assistant, an e-book, an electronic dictionary, a mobile communication device, a hand-held personal computer, an ultra mobile personal computer, a global positioning system, a portable game device, a digital still camera, or a digital video.

5. A multimedia playing device comprising:
a storage module storing an image, the image having a plurality of multimedia options, a portion of the image being defined as a projecting area;
a projecting module projecting the portion of the image corresponding to the projecting area;
a sensing module generating a sensing signal according to a movement of the multimedia playing device; and
a control module coupled with the storage module, the projecting module, and the sensing module, the control module moving the projecting area in the image according to the sensing signal.

6. The multimedia playing device according to claim 5, wherein an operation portion is defined in the projecting area, and if one of the multimedia options corresponds to the operation portion, the control module displays a playing instruction at the operation portion.

7. The multimedia playing device according to claim 5, wherein the sensing module has a movement sensing element for generating the sensing signal according to the movement of the multimedia playing device.

8. The multimedia playing device according to claim 5, wherein the multimedia playing device is a personal digital assistant, an e-book, an electronic dictionary, a mobile communication device, a hand-held personal computer, an ultra mobile personal computer, a global positioning system, a portable game device, a digital still camera, or a digital video.
